(19) United States
(12) Patent Application Publication
(10) Pub. No.: US 2003/0046011 A1
(43) Pub. Date: Mar. 6, 2003

(54) Method for ab initio determination of macromolecular crystallographic phases at moderate resolution by a symmetry-enforced orthogonal multicenter spherical harmonic-spherical bessel expansion

(76) Inventor: Jonathan M. Friedman, New York, NY (US)

Correspondence Address: James J. DeCarlo, STROOCK & STROOCK & LAVAN LLP, 180 Maiden Lane, New York, NY, 10038, US

(21) Appl. No.: 09/910,592

(22) Filed: Jul. 20, 2001

Related U.S. Application Data
(60) Provisional application No. 60/219,863, filed on Jul. 20, 2000.

(51) Int. Cl. G01N 31/00; G06F 19/00

(52) U.S. Cl. 702/27

(57) ABSTRACT

A computational method for the discovery and design of therapeutic compounds is provided. The methods used rely on an accurate inter-conversion of three-dimensional molecular spatial information between two alternative orthogonal representations. These methods enhance the accuracy for determining ab initio phases of macromolecular crystallographic structures at any desired experimental resolution limit. The computational technique employed utilizes a software program and associated algorithms. This method is an improvement over the current methods of drug discovery which often employs a random search through a large library of synthesized chemical compounds or protein molecules for bio-activity related to a specific therapeutic use. The development of computational methods for the prediction of specific molecular activity suggests a method for describing the contents of non-centro-symmetric sparsely packed crystals and the information provided therefrom will facilitate the design of novel chemotherapeutics or other chemically useful compounds.

### CROSS-REFERENCE TO RELATED APPLICATIONS

This application claims priority of U.S. Provisional Appl. Ser. No. 60/219,863, filed Jul. 20, 2000 under 35 U.S.C. §111(b).

### FIELD OF THE INVENTION

The invention pertains to the field of using computational methods in predictive chemistry. More particularly, the invention utilizes techniques in crystallographic molecular replacement for drug design and ab initio molecular phasing. The techniques rely on a software program with associated algorithmic functions, to optimize the prediction of the crystallographic phases and structure for molecules of interest including proteins or other molecules have therapeutic value.

### BACKGROUND OF THE INVENTION

The roles of medicinal chemist and crystallographer have not been altered in several Arid decades. Their efforts to identify the structure of chemical compounds and therefrom deduce their chemotherapeutic effects, thereafter devising more potent or less toxic variations of them for medicinal use, has long been one involving the arduous task of attempting to crystallize and test one compound at a time to determine individual bio-activity and efficacy. This system is made even more costly and time consuming by the fact that over 10,000 compounds must be individually tested and evaluated for every compound that actually reaches market as a chemotherapeutic agent, World Pharmaceutical News, Jan. 9, 1996, (PJB Publications). These facts have driven many scientists and pharmaceutical houses to shift their research from traditional drug discovery (e.g. individual evaluation) towards the development of high throughput systems (HTP) or computational methods that will bring to bear increasingly powerful computer technology for the drug discovery process. To date none of these systems have been proven to significantly shorten discovery and optimization time for the development of chemotherapeutic agents.

Accordingly, a need exists to optimize the prediction of bio-activity in chemical compounds such that the discovery and development of therapeutically valuable compounds is made more rapid and efficient.

### SUMMARY OF INVENTION

Described here are details about, simplifications for, and enhancements to the accuracy of our recently described method [Computers & Chemistry, 23, 9-23 (1999)] for determining ab initio phases of macromolecular crystallographic structure factors at any experimental resolution limit. To apply this method, one first finds points in the unit cell that can serve as centers for large in nonoverlapping spherical asymmetric units and chooses one such point, xₒ, as the origin of a set of spherical harmonic-spherical Bessel (SHSB) basis functions, S^{lmn}(xₒ,r,φ,θ). The complex-valued Fourier space representation, T^{lmn}(xₒ,hkl) of each real space basis function, S^{lmn}(xₒ,r,φ,θ) for one asymmetric unit is combined, by complex summation with the crystallographic symmetry related Fourier space representations of the remaining asymmetric units, to create the Fourier space representation of a joint SHSB basis function [Fₛₒₗₒ^{lmn}(xₒ,hkl)] that can serve as a component basis function to describe the contents of an entire unit cell. The coefficient of each component function in the full-cell SHSB expansion is determined by a weighted linear least squares procedure. Given here is a more detailed explanation of this least squares procedure, a description about the general behavior of the coefficient refinement that enhances the speed of the calculation by about 2 orders of magnitude, a description of a “zonally restricted” packing function for selecting the origin for component basis functions, a method for extricating the refinement process from local minima, a statistical evalution of the refined ab initio phases that are produced for one specific test case at moderate resolution, and a presentation of typical electron density maps that are obtained for the medium resolution (2.7 Å) phasing of tetragonal Staphylococcal nuclease.

### DETAILED DESCRIPTION

In a previous paper, we outlined a method for the ab initio phasing of sparsely packed (macromolecular) crystals by transforming the problem of phasing into one of finding complex expansion coefficients for that linear combination of symmetry constrained orthogonal models, which is optimally consistent with the experimental diffraction pattern. We described a useful choice of such non-overlapping symmetry-expanded orthogonal functions for which the number of required coefficients scales well with resolution; that is, the number of independent parameters to be determined does not greatly exceed the number of experimentally determined diffraction data for any choice of experimental resolution range.

This advantage arises because our method does not presume an atomic model and thus does not require high resolution data for adequate experimental data to parameter ratios. Earlier ab initio methods may have suffered from assumptions of atomicity or of dense packing of atoms that are difficult to maintain at the low experimental resolution and with the sparse packing typical of macromolecular structures. A further advantage for choosing the SHSB basis functions is that the resulting expansion is relatively insensitive to reasonable choices of the origin. The initial disadvantage of the method was the amount of time required for the calculation. For example, our initial calcuation for the tetragonal form of Staphylococcal Nuclease required 9 wk on 16 nodes of a parallel processing IBM SP2 computer. We describe here some observations about the initial calculations have allowed us to reduce the computation time by between one and two orders of magnitude. For the Staphylococcal Nuclease test case, the time required for one cycle of the calculation was reduced from 9 wk to 2 d. This shorter calculation time has allowed us to optimize the accuracy of the procedure for this test case.

We wish, now, to elucidate upon methods by which one may obtain reliable convergence in the determination of a, the complex coefficients of the alternative expansion, from an experimental diffraction pattern. We wish also to describe our application of these methods to determine ab initio phases for several proteins of known structure. Ultimately, here, we wish to provide a convincing demonstration of the utility of the electron density derived by these methods.

Overview of the Method:

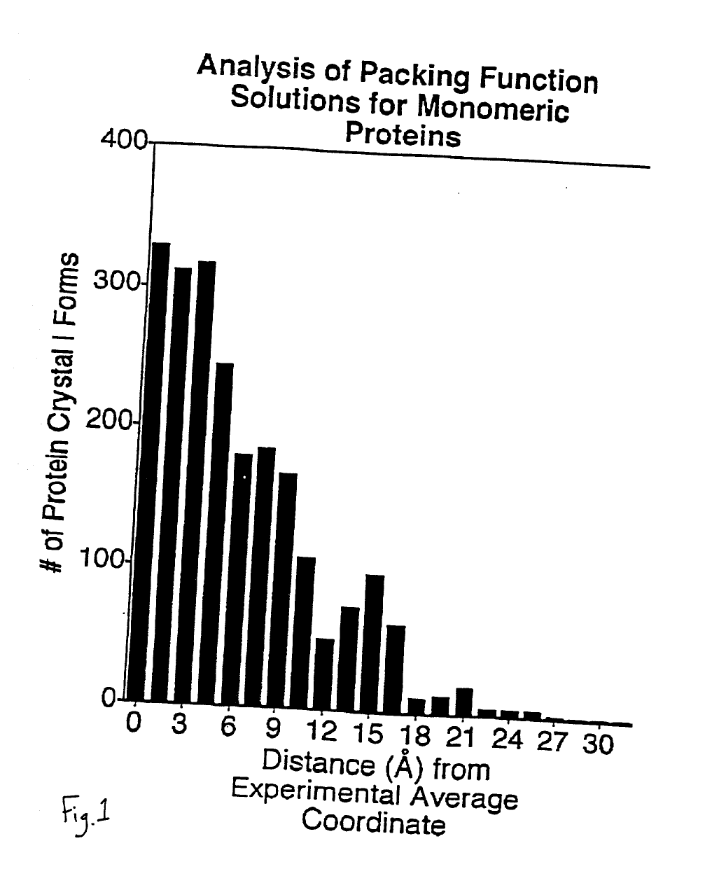

Although the values of the coefficients of a SHSB expansion may vary with the choice of origin, the fidelity of the reconstructed image does not depend on the choice of origin, provided that the non-zero portion of the expanded 3-dimensional function lies completely within each of the chosen spherical zones of expansion (FIG. 1a). Thus, if one wishes to find a “symmetry-enforced” orthogonal expansion of the contents of a crystallographic unit cell in terms of SHSB basis functions, one may partition the unit cell into crystallographically symmetrically related spherical zones of expansion one such zone for each asymmetric unit (FIG. 1b).* * Any similar complete set of orthogonal basis functions that avoids overlap between independent asymmetric units would suffice. However, if the basis set is chosen to be plane waves restricted to an entire asymmetric unit, i.e. the symmetry adaptation of a typical Fourier basis, then our method will break down because each plane wave basis function will be found to contribute only into a single reflection. This same feature of Fourier transforms gives rise to Heisenberg's uncertainty principle in quantum mechanics (Cohen-Tannoudji, et al., 1980). The more extensive the region is that we wish to describe in direct space, the less extensive is the region of Fourier space from which the corresponding information is available (and vice versa).

If a SHSB expansion is chosen, it would be convenient to describe the largest possible portion of the unit cell as a linear combination of these SHSB basis functions. Bearing in mind that these SHSB functions are identically zero outside of the zones of expansion, the origin for each asymmetric unit may be placed at a point in the unit cell that is far away from all points related to itself by crystallographic symmetry (Hendrickson & Ward, 1976). The radius is then chosen to avoid overlap between adjacent spherical zones of expansion. Such overlap would cause degeneracy of the best fit solution and this degeneracy might hinder convergence to a unique solution.

Given an appropriate choice of radius and origin for the SHSB zones of expansion, then at most between 45% and 55% of the unit cell's contents may be represented by the expansion. Macromolecular crystals generally have a solvent content of greater than 45%, or a macromolecular content of lower than 55% (Matthews, 1968xxx). Furthermore, the intervening solvent regions can often be considered to be featureless (Wang, 197xxxx). Thus this choice of partioning between described and undescribed regions of the macromolecular unit cell may adequately account for a large portion of the macromolecular contribution to the x-ray diffraction pattern. The failure to account for all of the space in the unit cell dictates that a certain portion of the macromolecular electron density may lie outside of the zones of expansion and will thus fail to be accounted. (i.e. Some unaccountable electron density will inevitably fall into the null space of this SHSB basis.) However, an appropriate choice of SHSB origin is expected to minimize the amount of this undescribed density (Hendrickson & Ward, 1976).

Given known phases for a crystallographic diffraction pattern, a unique SHSB expansion is obtained that reproduces the expanded 3-dimensional image with high fidelity (Friedman, 1999). Without known phases, but with a known diffraction amplitudes, one may try to approach a self-consistent set of phases by successive approximations. Even if such an approach leads to convergence, one must anticipate that convergence may result in one of several trivially related isometric solutions. These related solutions can be converted into each other by some well known formulae that are listed below, and electron density calculated from each choice of solution can be analyzed for consistency with expectation.

Isometric Solutions:

We were initially concerned that macromolecular diffraction patterns might not represent the contents of a unique unit cell. Thus far, the only solutions that have arisen by our method are ones related to some of the expected alternate solutions.

Some alternative distributions of electron density, ρ′(xyz), are expected to give rise to an experimental diffraction pattern that is identical to the diffraction produced by the actual crystal, except for differences in the values of the phase of each reflection. For instance, the photographic negative image of the unit cell gives rise to a diffraction pattern for which the calculated amplitude of each reflection is identical with the corresponding amplitude calculated for the true unit cell contents, but for which the phase of each reflection is different by 180 degrees. Likewise, the amplitudes of reflections from the enantiomeric unit cell are identical with calculated amplitudes for the true unit cell, but with the phase of each reflection different by a sign.

A third class of alternate solutions for many space groups are those that are related by an arbitrary translation of the unit cell origin. Here, again, these equivalent alternate choices of origin lead to identical diffraction intensities, but the phase of each structure factor F(h,k,l) differs by 360(hx+ky+lz) degrees, where (x,y,z) is the translation vector, in fractional coordinates, that relates the two equivalent unit cell origins. Any such choice of origin is equally valid, but for the best comparison of the agreement between two independent solutions, translation to a common origin, enantiomer and photographic image (positive or negative) is required. Thus it is expected that any ab initio phasing method might converge to a unique solution that differs from the true (or expected) solution, but from which the true solution can be easily obtained.

One concern is that linear combinations of these valid solutions may themselves be alternative valid solutions. This is not a concern for linear combinations of enantiomeric solutions.

Diagram xxx.

The imaginary components of the combined amplitudes cancel, but the real components are additive. Thus although the initial ratio of |F1| to |F2| I 1:2, the linear combination F(1)+F(1)*; F(2)+F(2)* of the enantiomorphs gives an approximate final ratio of 1:1.

Linear combination of the complex diffraction pattern arising from different enantiomers yields combined diffraction amplitudes that are inconsistent with the diffraction pattern of either enantiomer by itself; the relative amplitudes will vary markedly with the extent of the combination. Linear complex combinations of the diffraction of the positive and negative image of the unit cell, on the other hand, are expected to differ only in the overall scale of the calculated amplitudes. However, as will be discussed below, our choice of basis functions causes such linear combinations of the positive and negative photographic image unit cells to correspond to variation of the contrast between the molecular asymmetric unit and the solvent.

It is expected that convergence to the true solution is as likely as convergence to the enantiomorphic solution. However, in pairs of space groups with a chiral arrangement of general positions (eg. P3₁, & P3₂, P4₁ & P4₃, P6₂22 & P6₄22), it is expected that one enantiomorphic solution is dictated by the prior selection of one of the pair of enantiomorphic spacegroups. In space groups without a chiral arrangement of general positions, it is possible that individually derived aₗₘₙ coefficients of different Sₛₒₗₒ^{lmn}(hkl) component basis functions correlate optimally with different crystal enantiomorphs. Even if this is the case, appropriate combinations of the component Sₛₒₗₒ^{lmn} functions are expected to have higher correlation with the electron density than inappropriate ones. The same is expected to hold in Fourier space so that that F_{obs} will have higher correlation r(|F_{accum} |<−>|F_{obs}|) with internally consistent linear combinations of basis functions, F_{accum}(hkl), for one of the two enantiomorphs. Inconsistent linear combinations between terms from different enantiomorphs will give combined F_{accum}(hkl) functions with lower overall correlation versus the observed diffraction data when compared with combinations from a unique enantiomorph. In the absence of symmetry-derived crystal chirality, convergence to either unique enantiomorph is equally likely,^{†} but prior selection of origin xₒ may predispose the refinement to converge to one of the two enantiomorphs. ^{†} We note that none of the SHSB basis functions is chiral but that chirality arises from combinations of two or more SHSB functions both with odd valued l≧1 and odd valued m≧1 and from which the SHSB coefficient phase angles αₗₘₙ differ from one another by an angle other than an exact integral multiple of π radians.

The linear combination of the true solution with one related to its negative image results in an image with a different overall scale factor. Since the Fourier space structure factor with the phase of the negative image lies along the same line on the complex plane as the structure factor of the true solution, linear combination corresponds to an adjustment of the contrast between the macromolecule and the solvent. Provided that featureless regions (presumed to be the solvent regions) of electron density in the experimental unit cell correspond to regions that lie predominantly outside of the zones of expansion, then convergence to the direct image is expected for those solutions with the larger values of r(|F_{accum} |<−>|F_{obs}|). Convergence to the negative image may be encountered in densely packed crystals, for which the local absence of macromolecular electron density is more of a rarity than the local presence of ordered density. It may also result from inappropriately selecting the origin of the zone of expansion to lie in the very middle of a solvent cavity.

The key assumption of our method is that the choice of origin does not significantly affect the quality of the reconstruction, provided that the object for which the shape is being approximated lies predominantly within these spherical ranges. In the first test case that we examined, the symmetry-expanded models can account for about 80-90% of the non-solvent density in the P4₁ (uniaxial) unit cell of Staphylococcal Nuclease. If acceptance, at each stage of successive approximation, depends on the degree of cross-correlation between the observed diffraction amplitudes, F_{obs}(hkl), and the continually accumulated calculated structure factor, F_{accum}(hkl), then (1) an observed final high degree of cross correlation between F_{accum} and F_{obs}, and (2) observed convergence to corresponding phase sets from independent starting points both would suggest that the de facto choice of arbitrary unit cell origin by our procedure is one for which overlap between the strongly morphological region of crystallographic electron density and the spherical zone of expansion is automatically optimized. This is particularly important for uniaxial space groups, for which one coordinate axis is completely arbitrary, and for other space groups with several equivalent choices of origins. Similarly, increased effectiveness at describing the strongly morphological regions of the electron density may predispose the refinement to converge to that enantiomeric unit cell, which has a monomer with average coordinates closer to xₒ, the arbitrarily selected origin of expansion. However, it is not ruled out that weak cross-correlation with one of the alternative isometric solutions may still contribute to the overall noise level.

Zonally Restricted Packing Functions to Pick an Origin for the Basis Functions:

Our method requires that one pick an origin for the zone of expansion to be close to the average coordinate of a macromolcular monomer in the crystal. An exact match is not required. For the space group P1, any point in the unit cell is equally vaild, but an arbitrary coordinate other than the coordinate (0,0,0) is chosen to avoid a centrosymmetric arranagement of the SHSB basis set in the crystallographic unit cell. For space groups other than P1, the origin was originally chosen to be that point in the unit cell which is furthest away from all points that are related to itself by crystallographic symmetry. This corresponds to the global optimum point of the Hendrickson-Ward packing function. A quick check of 5 different readily available crystal structures suggested that this choice allowed one to obtain an origin within 5 Å of the average coordinate of the protein monomer.

A further, more detailed analysis, made-possible by an earlier systematic classification of the oligomeric states of proteins in the Protein Database (ref xxx), showed several deficiencies in this procedure. Shown in FIG. XXX is a histogram of distances between the absolute packing function optimum and the observed average coordinate of each of those xxxx monomeric proteins in the structural database that crystallized in space groups other than P1. The distances reported in this histogram are those to the nearest symmetry related monomer in either the true or the enantiomeric unit cell, with consderation of all possible choices of unit cell origin. Clearly, distances greater than 20 Å are expected to be insufficiently close for expansion zone radii on the order of 20 Å to 40 Å. To try to improve the selection of the origin, we considered local optima other than the absolute optima (FIG. xxx). This leads to some improvement, but still leaves a large percentage of crystal forms for which the closest of the top 20 peaks in the packing function still lies more than 12 Å away from the average coordinate of the closest monomer.

Inspection of some of the poorer matches, led us to realize that the global optimum of the packing functions for some of these poor matches corresponds to a noteworthy position in the unit cell, but one that was in the very middle of a solvent channel rather close to the middle of a protein region. Further comparison of the average fractional coordinate vectors of monomeric proteins in macromolecular crystal forms belonging to the same Laue group suggested that unit cells in each Laue group contain certain “sweet spots.” That is, the unit cell contains several points in fractional coordinates about which values for the average coordinate of the crystalline macromolecular monomers are clustered. Optima in zones about each of these points must considered seriously for a successful ab initio estimation of the average coordinate, even if the value of the packing function is somewhat below the global optimum in these zones. Thus it appears that our difficulties arose from an often observed clustering of local optima near the absolute optimum of the packing function. The values of the packing function among these clusters of local optima near the global optimum are often sufficiently great that they can swamp out local optima in the other zones.

Thus a two stage search is conducted. In the first stage the values of the packing function are examined coarsely, only at each of the “sweet spots.” In the second stage a finer search is conducted in independent regions near-the top 20 (30%xxx) of the “sweet spots”. Thus by imposing zonal restrictions, we mean that we are looking only for the local absolute maximum in each of the independent regions. The solutions found by this algorithm are distributed more evenly between the independent zones within the unit cell and one obtains the histogram of distances in FIG. xx. Each such 2-stage search takes an average of about 6s of real time using 16 parallel nodes on an IBM-SP2 computer. By using the zonal restrictions, then, one can get one point in the list of the top 20 to be within 5 Å of the average coordinate of a monomer over 95% of the time. In practice, one may carry out the initial stages of SHSB coefficient refinement (vide infra) and select that origin which yields the largest low order coefficients as an appropriate choice of origin.

To summarize the results to this point, it is possible to describe a single (“monomeric”) asymmetric object in space by a 3-dimensional spherical harmonic-spherical Bessel (SHSB) expansion:

$$\begin{matrix}{ρ}_{monomer} ( x ) = {Σ}_{lmn} {a}_{lmn} {S}_{monomer}^{lmn} ( {x}_{o} ; r , φ , θ ) \\ = {Σ}_{lmn} \vert {a}_{lmn} \vert {S}_{monomer}^{lmn} ( {x}_{o} ; r , φ , θ ) {ⅇ}^{{ⅈα}_{lmn}} \\ = {Σ}_{lmn} \vert {a}_{lmn} \vert {S}_{mono}^{lmn} ( {x}_{o} , {α}_{lmn} ; r , φ , θ ) ,\end{matrix} \qquad ( 1 )$$

where xₒ is the selected origin vector. Once the proper origin is selected, the crystallographic unit cell is filled with nonoverlapping monomeric basis functions, each rotated and translated by crystal symmetry. This symmetry expansion of the monomeric basis functions yields S^{lmn}ₛₒₗₒ(x,y,z):

Sₛₒₗₒ^{lmn}(xₒ,αₗₘₙ;r,φ,θ)=Σ_{sym}Sₘₒₙₒlmn( [symbol] _{sym}^{x}xₒ+t_{sym},αₗₘₙ;r, [symbol] _{sym}^{φ}φ, [symbol] _{sym}^{θ}θ) (2)

the joint, full-unit-cell basis function. The effect of complex multiplication by e_{iα}ₗₘₙ is a rotation of the initial Sₘₒₙₒₘₑᵣ^{lmn} basis function by the angle (αₗₘₙ/m.) prior to symmetry expansion. The task at hand, then, is to estimate the complex coefficients a, to obtain an estimate of

ρ_{unit cell}(xyz)=Σₗₘₙ|aₗₘₙ|Sₛₒₗₒ^{lmn}(xₒ,αₗₘₙ;r,φ,θ)=Σ_{sym}ρₘₒₙₒ( [symbol] _{sym}^{x}x+t_{sym})m (3)

where [symbol] _{sym} and t_{sym} correspond to operators that effect a unique crystallographic symmetry rotation and translation respectively.

We note that the aₗₘₙ coefficients in the above summations are complex numbers (i.e. aₗₘₙ=|aₗₘₙ|e^{iα}ₗₘₙ) when m≠0. Since the Fourier transform is a linear transformation and since the basis functions have a finite range, the Fourier transform of this summation is the summation of the Fourier transforms of each of the components.

$$\begin{matrix}{F}_{unit cell} ( hkl ) = {Σ}_{lmn} \vert {a}_{lmn} \vert {F}_{solo}^{lmn} ( {x}_{o} , {α}_{lmn} ; r , φ , θ ) \\ = {Σ}_{lmn} {Σ}_{sym} \vert {a}_{lmn} \vert {T}^{lmn} ( {x}_{o} , {( {α}_{lmn} ; ℜ )}_{sym}^{T} {}^{x} h ) \\ = {Σ}_{lmn} {Σ}_{sym} \vert {a}_{lmn} \vert {T}^{lmn} ( {( {α}_{lmn} ; ℜ )}_{sym}^{T} {}^{x} h ) {ⅇ}^{{2}_{π} {i}_{( h \cdot {ℜ}_{sym}^{x} xo + k * {t}_{sym} )}}\end{matrix} \qquad ( 2 )$$

Analytical expressions for the Fourier transforms of each of the component basis functions are known (Friedman, 1998; Crowther, 19xx; Dodson, 19xx), and thus one may construct a Fourier space combined basis function that represents a unit cell's worth of orthogonal basis functions. The numerical values of the SHSB basis functions were calculated by a robust recursion formula (ref) for which the m index varied the most slowly. This recursion is particularly convenient for this application because it permitted all αₗₘₙ coefficients with restricted phase values (m=0) to be calculated before αₗₘₙ coefficients with less restricted phase value.

Estimation of SHSB Coefficients and Refinement of the Orthogonal Model:

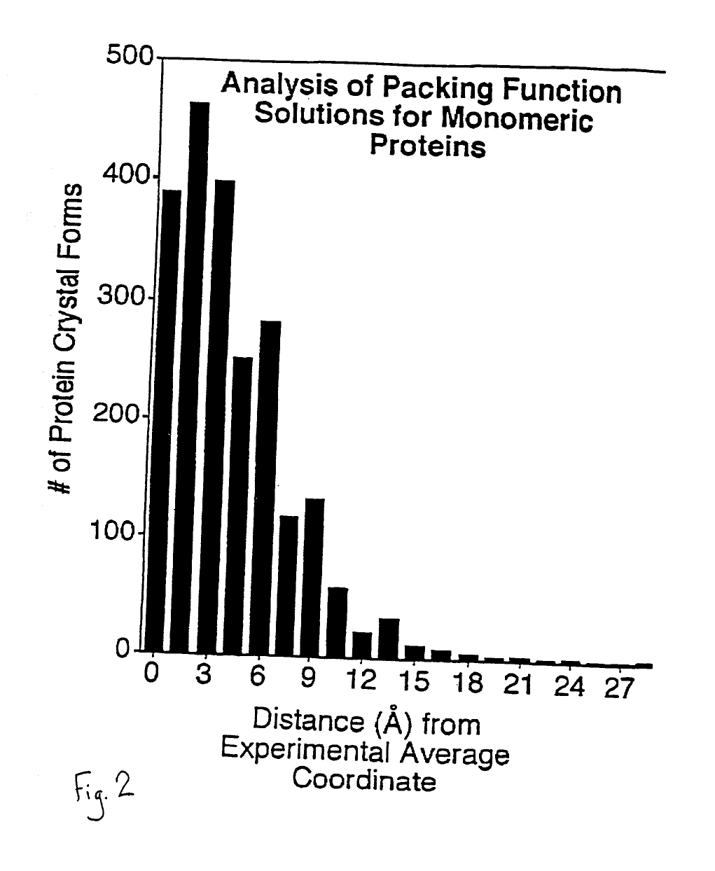

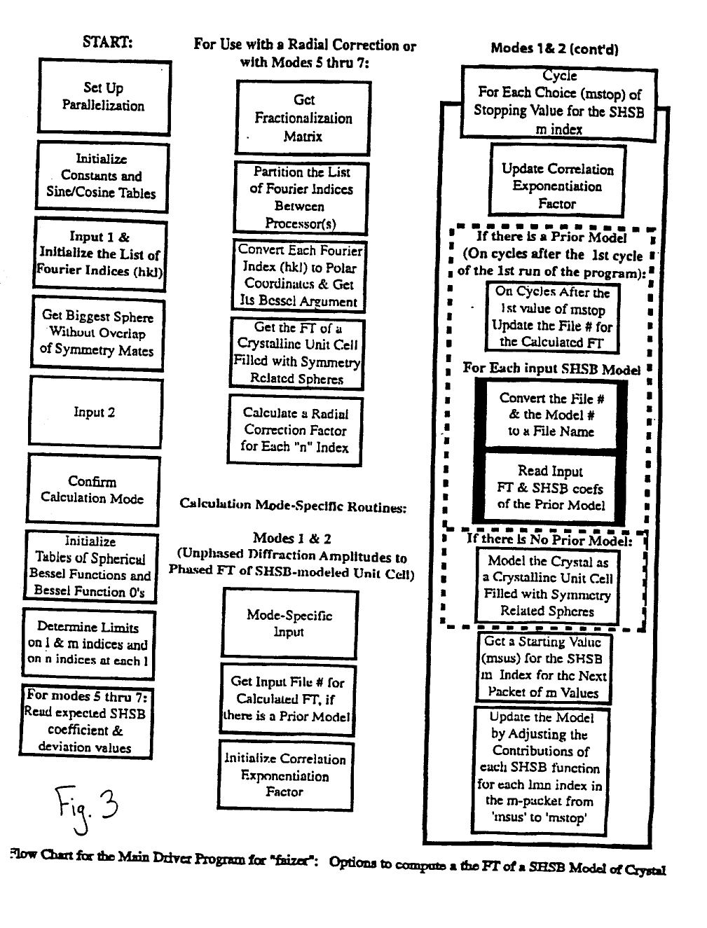

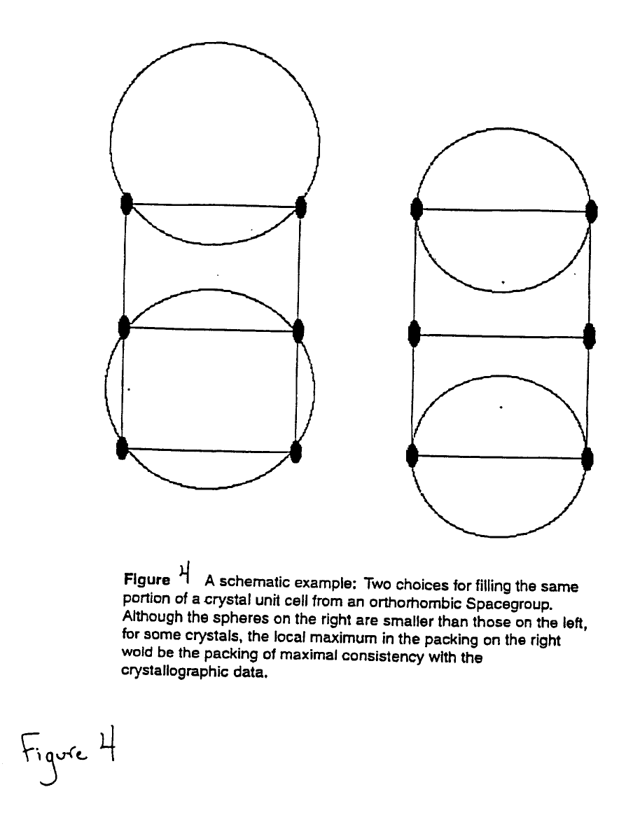

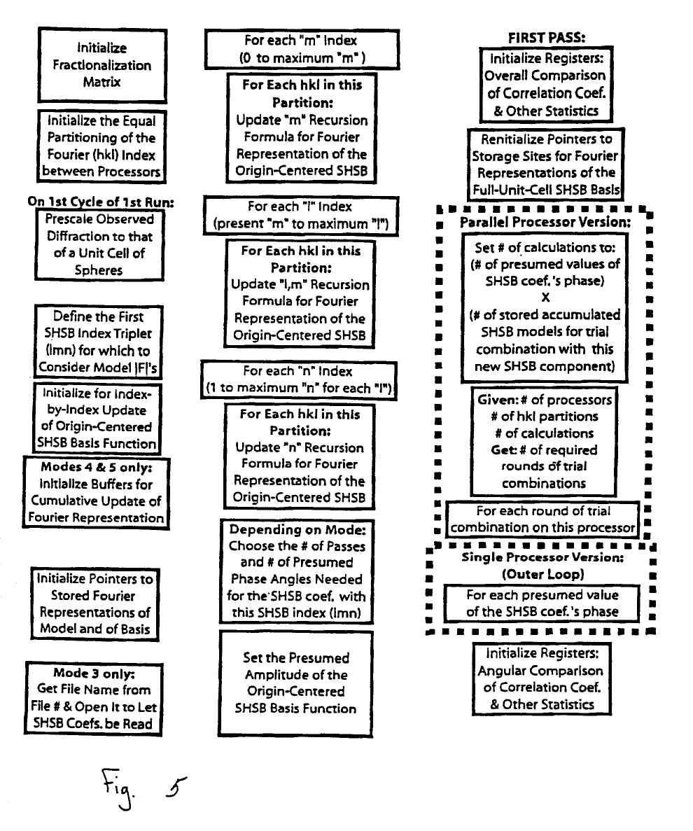

The Fourier space full unit cell basis function, Fₛₒₗₒ^{lmn}(αₗₘₙ; hkl) (FIG. 2), corresponds to the phased, Fourier space representation of a unit cell that has been filled with non-overlapping SHSB basis functions, Sₘₒₙₒ^{lmn}(xₒ, αₗₘₙ; r,φ,θ), that are related by crystallographic rotational and translation symmetry. The choice of this class of basis function combined with the required absence of overlap between adjacent component real space SHSB basis functions, Sₘₒₙₒ^{lmn} leads to orthonormality of the Sₛₒₗₒ^{lmn}:

$${\int }_{unit cell} ⅆ {{VS}_{solo}^{*}}^{lmn} {S}_{solo}^{l , {m}^{′} , {n}^{′}} = [ \begin{matrix}{N}_{sym} , & if l = {l}^{′} , m = {m}^{′} , n = {n}^{′} \\ 0 , & otherwise\end{matrix} \qquad ( 4 )$$

That each corresponding Fourier space component function, Fₛₒₗₒ^{lmn}(hkl), is also orthonormal in the same sense follows from Parseval's theorem, which equates integrals of functions in real space to the integrals of their Fourier space functional representations. The scale factor that we want, corresponding to the scale of the experimental unit cell to a union of non-overlapping component functions, would be a summation over direct space of the point by point product between Sₛₒₗₒ^{lmn} (the union of direct space basis functions Sₘₒₙₒₘₑᵣ^{lmn}) and the unknown crystallographic electron density. This is equivalent, within a sign, to the value of direct space convolution product at the single translation point t₀=(0,0,0). It therefore follows, from the convolution theorem, that the amplitude of the desired a, coefficient is equal to the inverse Fourier transform of the point by point Fourier space product, but only at the position x=(0,0,0). To obtain this value of the direct t space convolution product at the direct space position, x=(0,0,0), the Fourier kernel becomes equal to one and thus direct summation of the point by point product in Fourier space equals that in direct space. Unfortunately, an exact determination of αₗₘₙ requires prior knowledge of the phases of the Fourier space structure factors for the experimental electron density that is being expanded, because complex values must be used in the point by point Fourier space product. Thus, starting from diffraction amplitudes, the complex values of the coefficients aₗₘₙ may at best only be obtained by successive approximation.

Refinement of Amplitudes |αₗₘₙ|:

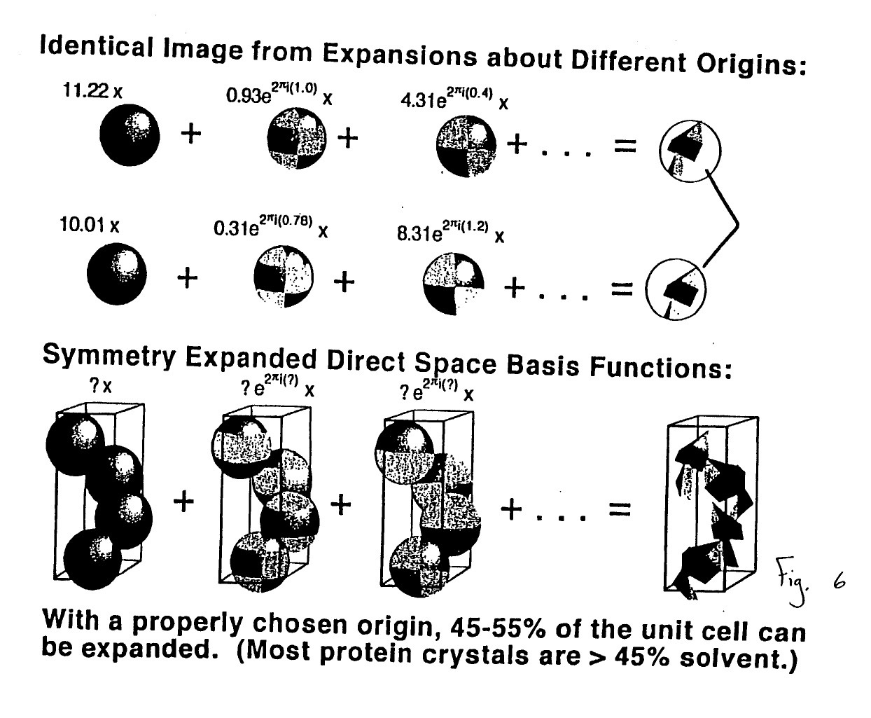

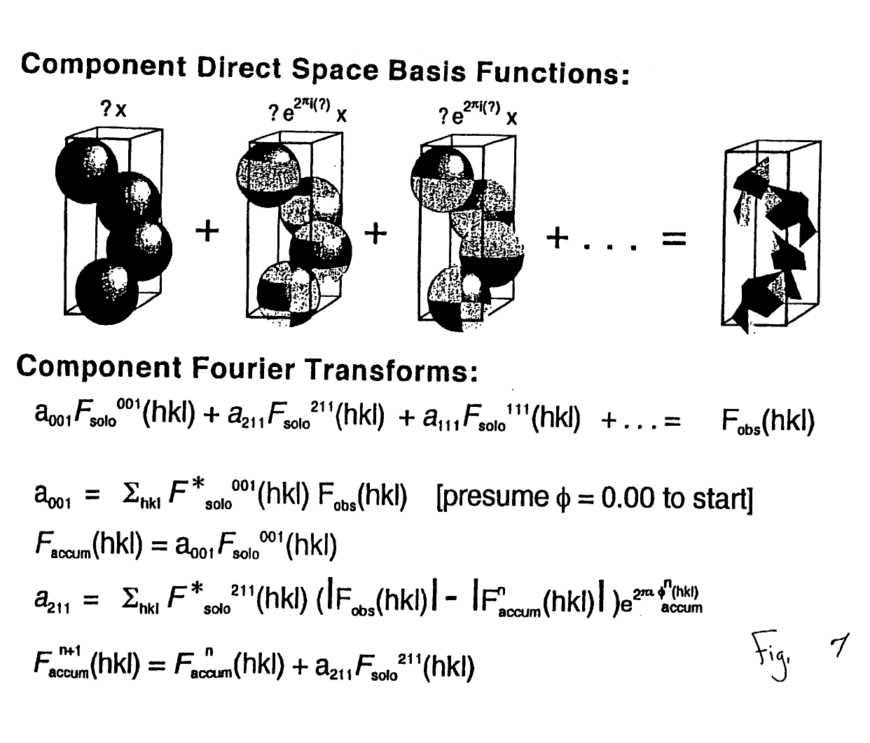

Our initial scheme to refine the orthogonal SHSB series model, in the absence of input phase information, was to use the current best estimates of the Fourier space phases and amplitudes at each stage in the calculation of subsequent coefficients. The idea was to use a refinement scheme that started with the determination of all SHSB expansion coefficients for which the value of the index m was 0. For these functions, the phase of αₗₘₙ is limited to be 0° or 180° by the physical requirement for non-imaginary values of the real space electron density (FIG. 3).

On the very first cycle and to a first approximation, we presume the totipotency of the symmetry expanded real space function Sₛₒₗₒ⁰⁰¹. That is, we assume that Sₛₒₗₒ⁰⁰¹,suitably weighted and with an adequately chosen origin, xₒ, can by itself (solo) account approximately for all of the electron density that gives rise to the experimental diffraction. (For earlier work with similar assumptions compare Podjarny et al. 199x.) If the assumption of totipotency holds approximately, then we can start accumulating a set of estimated structure factors based on this:

F_{accum}⁰(hkl)=a¹₀₀₁Fₛₒₗₒ⁰⁰¹(hkl). (5)

To obtain an initial estimate of the coefficient α₀₀₁, we use the expression:

a₀₀₁=ΣₕₖₗF*ₛₒₗₒ⁰⁰¹(hkl)F_{obs}(hkl)/(ΣₕₖₗF*ₛₒₗₒ⁰⁰¹(hkl)Fₛₒₗₒ⁰⁰¹(hkl)), (6)

which follows from the orthonormality of the Fₛₒₗₒ functions and is equivalent to a least squares scale factor.‡ The normalization term in Eq. (6), {1/Σₕₖₗ[F*ₛₒₗₒ^{lmn}(αₗₘₙ;hkl) Fₛₒₗₒ^{lmn}(αₗₘₙ;hkl)]}, should remain constant, but is calculated explicitly at each index to avoid possible numerical errors. In practice, we have found it necessary to weight these initial estimates of the coefficient values by one minus the probability that the correlation between F_{obs} and Fₛₒₗₒ^{lmn} is random. Use of this weighted aₗₘₙ coefficient allows one to calculate the initial estimate estimate of the complex Fourier structure factors: ‡ Essentially, F_{solo,lmn}(hkl,αₗₘₙ) is the Fourier space representation of a SHSB joint basis function with a coefficient of unit modulus and an arbiter phase. The question we ask is, “What is the proportionality factor between this basis function and F_{obs}, presuming that the phase of the SHSB coefficient (aₗₘₙ) is αₗₘₙ?” It is presumed that the proportionality is all real and thus the imaginary part is a measure of the goodness of fit. In terms of linear least squares (Strang, 1976), the real part is the projection onto the space of possible outcomes and the imaginary part represents the distance (and direction) from this presumed model space.

a¹₀₀₁=w(r_{Fobs-solo})a₀₀₁ (7)

$$w ( {r}_{Fobs - Fsolo} ) = 1 - erfc [ \frac{1}{2} \vert ln ( \frac{1 + {r}_{Fobs - Fsolo}}{1 - {r}_{Fobs - Fsolo}} ) \vert \frac{\sqrt{N - 3}}{\sqrt{2}} ] \qquad ( 8 )$$

On subsequent cycles (eg. cycle υ), we calculate a reduced structure factor, F_{reduced}(hkl), to use in place of the unphased F_{obs}(hkl) for comparison with Fₛₒₗₒ^{lmn}(αₗₘₙ;hkl). Again we presume totipotency of Fₛₒₗₒ^{lmn}(αₗₘₙ;hkl) in accounting for the remaining undescribed portion of the diffraction pattern (F_{reduced}) and scale each independent coefficient, in turn, by the following least squares relationship:

F_{reduced}^{υ}(hkl)=(|F_{obs}(hkl)|−|F_{accum}^{υ}(hkl)|)e^{|φ}^{_{accum}}^{υ} (9)

aₗₘₙ=Re{ΣₕₖₗF*ₛₒₗₒ^{lmn}(hkl)F_{reduced}^{υ}(hkl)/[ΣₕₖₗF*ₛₒₗₒ^{lmn}(hkl)Fₛₒₗₒ^{lmn}(hkl)]} (10)

a¹ₗₘₙ=w(r_{Freduced-Fsolo})aₗₘₙ (11)

F_{accum}^{υ+1}(hkl)=F_{accum}^{υ}(hkl)+¹ₗₘₙFₛₒₗₒ^{lmn}(hkl) (12)

Phases (αₗₘₙ) of the Expansion Coefficients αₗₘₙ, the m=0 Terms:

We always make use of prior approximations to the electron density by using calculated phases from each previous cycle as the best estimate for phases associated with complex Fourier space values. The values determined in the previous section only address the scale factors between F_{reduced} and Fₛₒₗₒ, for a single presumed value of αₗₘₙ, and thus only the amplitudes of the expansion coefficients αₗₘₙ. When the value of the index m equals zero, αₗₘₙ is limited to values along the positive or negative real axis by the restriction that the unit cell contain completely real electron density. Physical intuition would dictate that, with a proper choice of expansion zone radius, choice of the expansion zone origin near to the monomeric center of mass (or average coordinate) should cause the value of the coefficient a₀₀₁ to be large and positive. However, in our application, diffraction patterns Fₛₒₗₒ⁰⁰¹ corresponding to α₀₀₁=0° and α₀₀₁=180° are both stored for further refinement. Our initial refinement scheme entailed saving accumulated diffraction patterns (F_{accum}) corresponding to as many combinations of the choices of αₗₘₙ, as was allowed by allotted computer memory. (Storage space for up to 16 independent F_{accum} functions was routinely available.) Once memory became exhausted, only those accumulated solutions F_{accum} with the top cross-correlation between |F_{obs}| and |F_{accum}| were retained. By refining the m=0 terms first, in effect, we are first determining phases for a model that is presumed to be rotationally averaged about an arbitrary “z” axis, (which is arbitrarily chosen to-coincide with the c-axis of the crystal for the initially calculated monomer).

Phases (αₗₘₙ) of the Expansion Coefficients αₗₘₙ, the m≠0 Terms (The Slow Calculation)

Comparison of the complex cross-correlation values is also carried over to those aₗₘₙ coefficients for which the values are not limited to be real. In this case, Fₛₒₗₒ^{lmn}(xₒ,αₗₘₙ;hkl) in eqs. 6 & 8 again (xxx) is that diffraction pattern arising from a unit cell filled by crystallographic symmetry expansion of the direct space basis function Sₘₒₙₒ^{lmn}(xₒ,αₗₘₙ;r,φ,θ). The argument αₗₘₙ indicates that this full-unit-cell basis function is calculated by premultiplying the initial monomeric direct space basis function by e^{iαlmn} prior to symmetry expansion and the argument xₒ indicates the chosen origin of the expansion zone for this initial monomeric basis function. To select a value for αₗₘₙ, we initially calculated plots of r_{solo-red} [i.e. the complex correlation coefficient between Fₛₒₗₒ^{lmn}(xₒ,αₗₘₙ;hkl) and F_{reduced}(hkl)] versus the presumed value of aₗₘₙ. The unweighted modulus of the coefficient aₗₘₙ=Aₗₘₙe^{iαlmn} is chosen to be the scale factor at one of the angular optima in the r vs. α plot. The computer program was initially set to consider weighted Fₛₒₗₒ^{lmn}(xₒ,αₗₘₙ;hkl) functions for up to 16 of these optima with respect to αₗₘₙ. In this initial, slower calculation, we presumed, in turn, 72 values of αₗₘₙ, at 5 degree intervals, from 0 to 355 degrees inclusively, when m≠0. Because storage space was limited, two separate cycles were run. On the first cycle, Fₛₒₗₒ^{lmn}(αₗₘₙ) was calculated for all 72 values of aₗₘₙ, and the r vs. α plot was calculated. Those with the best cross-correlation to F_{reduced} were found and noted, but not stored. On the second cycle, these top 16 optima were stored and tried again with each of the 16 stored values of F_{accum}(hkl). The maximum number of storage locations for F_{accum} (hkl) functions was a compile time parameter that could be changed arbitrarily. In the original version, we tested two different choices for this parameter and found that some significant solutions were discarded if only 8 of the F_{accum} (hkl) functions were stored at each cycle. The source code allowed distribution of the computation evenly among an arbitrary number of parallel processors for (1) the 1152 (=72×16) test summations on Cycle 1, i.e. the initial plot of r_{solo-red} vs. αₗₘₙ, (2) for the 256 test summations on Cycle 2, and (3) for the initial least squares scale factor. Below we note some observations that now allow us to forego most of these comparisons.

The ultimately chosen value of αₗₘₙ is that value which leads to the highest absolute value of complex correlation† between the basis vector F^{lmn}ₛₒₗₒ(hkl) and the remnant “data” vector (F_{reduced}(hkl), the RHS vector). At each stage F_{accum}(hkl) is updated (Eq. 12) to include all prior knowledge from previous cycles. Also, cycle by cycle rescaling of F_{accum} to F_{obs} prevents the value of the the scale factor between these two Fourier space functions from wandering. \ This complex correlation is a correlation function between a paired list of complex numbers for which all product terms (f₀f₁) in the normal definition of the correlation coefficient are replaced by the complex product (f₀* f₁). In terms of the complex arguments (phase angles) φ₀ and φ₁:

$${r}_{01} = \frac{\begin{matrix}n \sum [ {f}_{0} {f}_{1} cos ( {φ}_{0} - {φ}_{1} ) ] - \\ \{ \sum ( {f}_{0} cos {φ}_{0} ) \} \{ \sum ( {f}_{1} cos {φ}_{1} ) \} - \{ \sum ( {f}_{0} sin {φ}_{0} ) \} \{ \sum ( {f}_{1} sin {φ}_{1} ) \}\end{matrix}}{\begin{matrix}[ n \sum ( {f}_{0}^{2} ) - {\{ \sum ( {f}_{0} cos {φ}_{0} ) \}}^{2} - \\ {{{\{ \sum ( {f}_{0} sin {φ}_{0} ) \}}^{2} ]}^{1 / 2} [ n \sum ( {f}_{1}^{2} ) - {\{ \sum ( {f}_{1} cos {φ}_{1} ) \}}^{2} - {\{ \sum ( {f}_{1} sin {φ}_{1} ) \}}^{2} ]}^{1 / 2}\end{matrix}}$$

The αₗₘₙ values determined as described above are only approximate, because the best estimate of the phases of the accumulated calculated structure factors (φ^{υ}_{accum} in Eq. 9) at each cycle is also approximate. We wished to determine empirically whether such estimates of αₗₘₙ could be refined by successive approximation to φ_{accum}. As described above, several F_{accum}(hkl) solutions were stored at each cycle for each combination between F_{accum}(hkl) from a prior cycle and Fₛₒₗₒ(xₒ,αₗₘₙ;hkl) with presumed values of αₗₘₙ that gave rise to optimal cross-correlation. The intent of such a multisolution method was to circumvent the coarseness in the choice of αₗₘₙ and to circumvent possible problems arising from accidentally high correlation between Fₛₒₗₒ and isometric distributions of “remnant” electron density.

Although the position of the basis function origin in the reconstructed, calculated unit cell is fixed, such “accidentally” high correlation between a single basis function [Fₛₒₗₒ^{lmn}(hkl,αₗₘₙ)] and poorly phased diffraction data may result from an inappropriate comparison with electron density in a unit cell for which the arbitrary origin, enantiomer, or photographic image differs. For proteins that crystallize in uniaxial space groups, such as Statphylococcal Nuclease, even for the right enantiomer and photographic image, accidental correlation may be found with electron density in a unit cell related by an arbitrary z-translation. Comparison of correlation coefficients between the observed structure factor amplitudes F_{obs} and a precombination Fₛₒₗₒ^{lmn}(hkl,αₗₘₙ) with F_{accum}(hkl) should allow fixing to a common origin. However, on preliminary cycles where _{accum} is poorly defined, the degree of inaccuracy in the current estimates of F_{accum} can still lead to inconsistency in the choice of origin.

Thus, the aₗₘₙ coefficients were improved recursively. The combined estimate of aₗₘₙ appears to become more well determined as the current overall estimated F_{accum}(hkl) becomes better defined.

In this fashion, successive approximation was achieved but at a high cost in terms of CPU hours.

To avoid having the approximate nature of the φ_{accum} cause the optimization of αₗₘₙ to stray too far from the true solution, constant retracing (i.e. correction of previously determined values of αₗₘₙ) was undertaken. Thus, in the initial slow calculation, before proceding to the next higher value of the m index (m_{new}), corrective approximation to αₗₘₙ was restarted from the index m=0, and carried out over aₗₘₙ with all intervening values of m.

Observations from the Slow Calculation:

(1) The variation of correlation coefficients with presumed αₗₘₙ value is, in general, unimodally sinusoidal for basis functions with nonzero values of the m index. Typical plots of r(F_{obs}{−Fₛₒₗₒ}<−>Fₛₒₗₒ) vs. aₗₘₙ are shown in FIG. XXX and are overlaid with plots of the imaginary residual of Aₗₘₙ‡ vs. αₗₘₙ. [to figure caption: To conserve disk space, the program is set to plot out only one of every five of the presumed phase angles that are actually considered for acceptance by the calculation. ](Fix XXX). The scale factor is only approximately unimodal and is generally out of phase with the correlation coefficient sinusoid. Thus, rather than calculating scale factors and correlation coefficients for 72 independent presumed values of αₗₘₙ, it is only necessary to calculate initially those for 2 presumed values of αₗₘₙ, 0° and 90°. From these two values and an arc tangent function, we can find the αₗₘₙ value at optimal correlation. This reduces considerably the amount of calculation power that is necessary; alone this improvement reduced the time from 9 weeks to less than 1 week. † See the earlier footnote with this symbol.

(2) Convergence of the aₗₘₙ coefficients to >95% stability is generally achieved after about 4 to 6 recursive cycles of refinement. Initially, we restarted from m=0 before the initial calculation of coefficients for the next higher value of the m index (m_{new}), to avoid wandering. We find instead that one needs only restart the calculation from m=m_{new}−4 or m=m_{new}−5. We suggest that, for higher accuracy, the entire process should be restarted several times (at least twice) from m=0; however, from analysis of the updated chances in coefficient values at lower m index (See eg. table XX), we find that we were initially overly conservative in the extent of reoptimization of coefficients for the lower order indices.

(3) The calculation may be skipped for those basis function for which the weighted coefficient is smaller than a set cutoff value. A convenient cutoff value is 10⁻⁷ times the value of the coefficient with the greatest absolute value of the coefficient a on a given cycle.

With the above improvements, the time required for fitting the 2.7 Å Staphylococcal Nuclease data or the calculation was reduced from 9 wk on 16 nodes to 2 d on 4 nodes. This reduction in the time for the calculation of phases allowed us to vary several other parameters of the refinement to see whether obvious improvements could be obtained. At present, the reduction in the required number of comparisons, due to the sinusoidal dependence, leaves the initial parallelization scheme inefficient if more than 4 nodes are used. Additional improvements in the parallelization are expected to improve the speed of the calculation even further. For problems with more moderately sized proteins and higher symmetry, the time for 1 cycle of refinement is still 1 to several weeks.

Electron Density Calculation:

The result of the SHSB expansion calculation is a set of reconstructed Fourier coefficients (F_{accum}(hkl)) that are continuously updated (accumulated) throughout the expansion procedure. These may be treated as a set of calculated structure factor amplitudes and phases in some of the generally used types of weighted difference Fourier maps. We initially tried to use σ_{A} wieghted 2Fᵢ-F_{c} style electron density maps (R.Reed xxxx), and were surprised to find that the optimal choice of σ_{A} resulted in maps for which the suggested weighting provided a 2FCF. map, rather than a 2F_{c}-Fₒ style map. As expected, this leads to positive electron density for the region of the protein, within the confines of the spherical zone of expansion, and negative electron density in the regions outside of the expansion zone. These external regions are undecribed by the calculated model. The map which optimally matched the known test structure was a 2Fₒ-F_{c} map using Sim weights (ref to Sim xxx).

One can rationalize this observation by noting that Sim's original derivation presumed that the sole source of error between F_{calc} and F_{obs} derives from missing atoms, i.e. electron density that has not been included in the present model. The derivation of the σ_{A} weighting scheme expanded upon Sim weighting by also accounting for positional error in the atoms that already have been included in the model.

Extent of the Spherical Harmonic Expansion Indices:

Different upper limits for indices l, m, and n have been suggested by different authors for the description of centrosymmetric diffraction data. In the present application of the spherical harmonic basis, we must achieve a compromise between maximal descriptive content and a minimal ratio of statistical parameters to number of experimental data. Several different choices of index limits were assessed for the case of phasing the P4₁ form of Staphalococcal Nuclease at 2.8 Å (xxxx unique calculated diffraction amplitudes). These choices included:

(1) A full complement of l and n indices but an artificially low cutoff in the index m to avoid underdetermination (xxxx data, xxxx SHSB amplitudes, xxxxx SHSB signs, xxxx SHSB phases).

(2) The full Crowther/Navazza cutoff for 2.8 Å diffraction data (xxxx data, xxxx SHSB amplitudes, xxxx SHSB signs, xxxx SHSB phases.) It may be argued that the SHSB coefficient phases contain less information than the SHSB amplitudes because of their more restricted range of values. This trial choice of cutoff was chosen to demonstrate the effect of completely ignoring the low data to parameter ratio.

(3) The full Crowther/Navazza cutoff for 2.8*(2)^{⅓}Å diffraction data. This effectively reduces the resolution of the calculated diffraction pattern to that of a diffraction pattern that fills half of the Fourier space volume of the true experimental diffraction data. This allows the Fourier space values |F_{cal}|(hkl) and φ_{cal}(hkl) to be determined by an equal number of experimental observations |F_{obs}(hid)|.

Recursive Improvement of Initial Estimates of αₗₘₙ:

Recursive improvement is accomplished by finding complex valued corrections to the initial coefficents by fitting F_{solo,lmn}'s to the complex difference, (F_{obs}-F_{accum}). Two different methods were examined for recursive improvement of the aₗₘₙ coefficients. In the first of these, initial estimates were determined for all coefficients before any recursive improvement was started. The second method involved recursive improvement of all indices up to index m−1, before any new coefficients of index m were determined. (Only the first cycle, at index m=0, lacked prior recursive improvement.)

After all coefficients with a given m index have been estimated, it is likely that the resulting F_{accum} is a better estimate of Fₑₓₚₜ than the prior, less complete summations. Complex valued corrections are necessary due to the contributions arising from accidental correlation to alternative solutions in preliminary estimates of aₗₘₙ.

The Computational Algorithm:

A flow chart of the algorithm is outlined in FIG. xxx. Several calculation modes have been incorporated into the program for convenience. Parallelization is crucial only to those calculation modes that determine crystallographic phases from experimental amplitudes (modes 1 and 2):

Mode 1 f_{obs}→fₑₛₜ, maximum |r| is considered to be the optimum

Mode 2 f_{obs}→fₑₛₜ, maximum r is considered to be the optimum

Mode 3 f_{calc}→a_{lmn,calc} (known phases for f_{calc})

Mode 4 a_{lmn,calc}→f_{calc} (known phases for a_{lmn,calc}).

Empirical comparison of modes 1 and 2 reveals that mode 1 converges to solutions with higher combined overall correlation and chooses solutions that are more often consistent with minimal values for the imaginary residual in Aₗₘₙ. Recursive improvement is only required if complex phases are not known for either f_{calc} or aₗₘₙ coefficents. Thus no recursion or probabilistic comparison of correlation coefficients is required for modes 3 and 4.

aₗₘₙ=∫_{r<a}_{_{rad}}ρ(r,φ,θ)j_{lb}r)Y*^{ml}(φ,θ)r²sinθ dr dφdθ (1)

The function Sₗₘₙ(r,φ,θ)=jₗ(kₗₙr)Y*^{ml}(φ,θ)

aₗₘₙ(0,0,0)=Nₗₘ×(−1)^{l}4πkₗₙ(2a_{rad})^{½}Σₕ|Fₕ|e^{i(ψh-πl/2-mφh)pm}ₗ(cos θₕ)jₗ(2πRₕa_{rad})/(4π²Rₕ²−kₗₙ²), (2)

where Nₗₘ is a normalization term equal to sqrt{[(2l+1)(l−m)!]/[4π(l+m)!]}. In this

aₗₘₙ(tₓ,t_{y},t_{z})=Nₗₘ×

(−1)¹4πkₗₙ(2a_{rad})^{½}Σₕ|Fₕ|e^{i(ψh-π½-mφh)pm}ₗ(cos θₕ)jₗ(2πRₕa_{rad})/(4π²Rₕ²−kₗₙ²)e^{-2πi(Ht}^{ₓ}^{+Kt}^{_{y}}^{+Lt}^{_{z}}⁾ (3)

ρ(rₛ,φ,θ,tₓ,t_{y},t_{z})=Σₗₘcₗₘ(rₛ,tₓ,t_{y},t_{z})Yₗₘ(φ,θ)

and the corresponding required coefficients are given by:

cₗₘ(rₛ,tₓ,t_{y},t_{z})=Nₗₘ×(−1)^{l}4πΣₕ|Fₕ|e^{u(ψg-π½-mφh)pm}ₗ(cos θₕ)jₗ(2πRₕrₛ)e^{-2πi(Ht}^{ₓ}^{+Jt}^{ₜ}^{+Lt}^{_{z}}⁾ (5)

ρ(x,y,z)=ΣₗₘₙaₗₘₙSₗₘₙ(r,φ,θ,tₓ,t_{y},t_{z})=ΣₕF(h)e^{-2πihx} (6)

F(h)=Nₗₘ×(−1)^{l}4π(2a_{rad})^{½}e^{2πih·t}Σₗₘₙa_{knb}(t)e^{i(mφ}^{ₕ}^{+πl/2)}kₗₙP^{m}ₗ(cos θₕ)jₗ(2πa_{rad}Rₕ)/(4π²Rₕ²−kₗₙ²). (7)

‡ ‡The appropriate integral for equations (9) & (10) is now equivalent to 5,54.2, p. 634 in Gradshteyn & Ryzhik (1980).

The original parallel algorithm for FAIZER used a single processor (node) for each combination of Fsolo and Faccum. If it were necessary to combine Fsolo's, each calculated with 72 different presumed values of the SHSB alpha angle, with 16 different stored lists of Faccum, then the 72×16 calculations could be split relatively efficiently between nodes. However, once it was found that only two choices of presumed alpha angles for the SHSB-coefficient for Fsolo were necessary for each calculation of a coefficient value, then the original parallelization scheme was found to be markedly inefficient. That is, combination of two choices of Fsolo (each having a value for the presumed alpha phase angle set at either 0 or 90 degrees) with two choices of Faccum, would have allowed at most four processors to be used efficiently for the calculation of scale factors and complex correlation coefficient values between Fsolo and Faccum-Fobs. Therefore, to speed the calculation further, parallelization was accomplished by splitting long summations efficiently between several nodes for the calculation of values of the {Faccum-Fobs,Phi.accum} <−>{Fsolo,Phi.solo} scale factor and for the calculation of the corresponding correlation coefficient. The program was modified to determine the most efficient splitting of each branch of the calculation between variable numbers of nodes, based on the number of nodes available and on the required number of branches of the calculation. For example, for Fsolos and Faccums each containing a list of 10,000 diffraction data, if 4 processors are available for a single calculation of a scale factor, the newly parallelized calculation will sum about 2,500 numbers on each processor and then combine the 4 partial sums afterwards, cutting run time for the calculation approximately by a factor of 4. The difficulty in achieving such parallelization is in maintaining that each partial summation within a branch of the calculation is combined with proper, corresponding branch members. Such proper communication was achieved with intra-communicator subroutines available from the MPI-Library. Further difficulty may arise if time required for internode communication begins to be similar to the time required for the calculation.

[image]

[image]

[image]

[image]

[image]

[image]

[image]

### SUMMARY OF THE METHOD

Everything is done on a grid. (Allows (FFT).

Find possible translation sites.

Expand the potential functions for each protein in terms of Sₗₘₙ. (A couple of hours).

Store the expansions of the spatial distribution of (charge/van der Waals) parameters for all drugs in a database. (A few days).

Fast searches for each drug using phased Crowther rotation search at each possible translation point. (Fraction of a second per site per drug).

The arbitrary choice of origin that is apparent from the application of spherical harmonic-Bessel expansions toward a six-dimensional search, and the high fideli6y for interconversion between the spherical harmonic-Bessel and Fourier representations suggest a method for describing the contents of a sparsely packed, non-centrosymmetric crystalline array in terms of multiple, non-overlapping, symmetry-enforced expansion zones. If all of the non-null electron density in a crystalline unit cell is contained within the limits of several non-overlapping spherical expansion zones placed into this crystalline cell, one may use the interconversion process to estimate the complex valued spherical harmonic-Bessel expansion coefficients from an incomplete Fourier description (diffraction amplitudes).

Each spherical harmonic-Bessel basis function of the representation can be used to generate an aggregate orthogonal basis function over a large portion of the entire unit cell. One applies crystal symmetry to rotate and translate an initial single-center spherical harmonic-Bessel j basis function from within a single spherical expansion zone into several non-overlapping, crystal symmetry-related spherical expansion zones. One may multiply the initial basis function by a complex coefficient of unit amplitude and arbitrary complex phase prior to symmetry expansion. Conversion of the full unit cell aggregate spherical harmonic basis into the Fourier-basis results in a partial structure factor for index lmn. (In practice we calculate the same ‘aggregate basis function’ partial Fourier structure factor by first converting the initial single-sphere basis function tot he Fourier representation and then applying the symmetry.) For each choice of arbitrary spherical harmonic coefficient phase angle, the scale factor between this ‘aggregate-basis function’ partial Fourier structure factor and an experimental diffraction pattern gives an estimate of the amplitude of the true spherical harmonic-Bessel coefficient. The correlation coefficient between this first ‘aggregate-basis function’ partial Fourier structure factor and the experimental, incomplete Fourier representation (diffraction amplitudes) gives an indication of the goodness of fit. Differences in this correlation coefficient may be used to select an optimal complex valued spherical harmonic-Bessel coefficient from among several initially arbitrary choices of complex phase angles for the coefficient of the spherical harmonic-Bessel basis function. Thus, the amplitude of each spherical harmonic-Bessel coefficient can be chosen as the least squares scale factor between the aggregate basis function and the diffraction pattern; the complex phase of each spherical harmonic-Bessel coefficient can be chosen to be that which optimizes the correlation coefficient between the Fourier representation of the basis function and the diffraction pattern. The orthogonality of the aggregate spherical harmonic-Bessel basis functions results in a lack of correlation between the coefficients calculated for the different component basis functions (i.e. for those with different values of the indices l, m and n). Thus, if all of the density in a crystal lies within expansion zones, one obtains a unique expansion. As this condition breaks down, there is expected to be a gradual accumulation of error in the diffraction pattern reconstructed from the spherical harmonic-Bessel basis. (The error arising from electron density outside of the expansion zones is exacerbated if the number of coefficients used in the spherical harmonic-Bessel expansion exceeds the number of available Fourier amplitudes.)

Because of the arbitrary nature of the origin for the expansion zones, the expansion zone can be chosen to be that which allows the maximum volume of the unit cell to be contained within non-overlapping expansion zones after symmetry expansion of the initial basis function. Up to about 55% of the unit cell's contents can be accounted for in this manner, a percentage commensurate wit the non-solvent regions of most macromolecular crystals. The method is expected to be exact if all of the nonzero electron density lies within these expansion zones and the electron density outside of these expansion regions has a value that is uniformly zero. We have examined a few macromolecular crystals of known structure and have found that the experimental average coordinate of each asymmetric unit tends to lie within a few A of those points in a unit cell that, when chosen as an origin, allow the largest spheres to be packed within the crystal lattice. (See also Hendrickson and Ward, 1976). Using these largest possible spheres, we have been able in one test case (nuclease from Staphylococcus aureus) to generate an accumulated diffraction pattern of a unit cell with enforced non-centrosymmetric crystal symmetry that has from 90-95% correlation with the amplitudes of the diffraction pattern calculated from the experimental coordinates. We are presently examining the general utility of this method for describing the contents of sparsely packed, non-centrosymmetric crystals and will report on these shortly.

We have described methods for the accurate conversion between a phased Fourier and spherical harmonic-Bessel representation. We have also shown that the resulting spherical harmonic-Besel representation may be applied to a relatively rapid automatic six-dimensional overlap search that can utilize our previously described accurate target functions. While computation times for the exhaustive search appear to be substantially faster than previously exhaustive calculation schemes, and we have introduced improvements that result in accurate calculations at points on a 6-dimensional grid, the new problem that arises for a library-based search is one of rapid data storage and retrieval. Toward these ends, we are optimizing the file structures and the sorting schemes within our databases and we are carrying out test calculations for trial partial databases. We plain to convert more extensive molecular structural databases to lists of spherical harmonic coefficient for further tests. We also have briefly introduced an additional application of multi-center spherical harmonic-Bessel representations toward the description of the contents of an asymmetric unit of a sparsely packed, non-centrosymmetric crystal.

### REFERENCES INCORPORATED BY REFERENCE

Arnold, C. M., Simon, S. I. , and Friedman, J. M. (to be submitted, Journal of Biological Chemistry).

Buerger, M. J. Vector Space, Wiley & Sons, New York, 1959.

Chapman, M. S., Tsao, J., and Rossmann, M. G. (1992) Acta Crystallographica, A48, 301-312.

Cooley, J. and Tukey, J. W. (1965)Mathematical Computation, 19, 297-301.

Crowther, R. A. (1972)The Molecular Replacement Method, M. G. Rossmann, Ed., Gordon & Breach, New York, pp. 173-178.

Dodson, E. J. (1985) Molecular Replacement: Proceedings of the Daresbury Study Weekend, 15-16 February 1985, P. A. Machin, Ed., SERC Daresbury Laboratory, Warrington, England, pp. 3345.

Fitzgerald, P. M. D. (1988) Journal of Applied Crystallography, 21, 273-278.

Friedman, J. M. (1997) Protein Engineering, 10, 851-863.

Gradshteyn, I. S. and Ryzhik, I. M. (1980) Table of Integrals, Series, and Products: Corrected and Enlarged Edition, Academic Press, Orlando.

Harrison, R. W., Kourinov, I. V. and Andrews, L. C. (1994) Protein Engineering, 7, 359-369.

Hendrickson, W. A. and Ward, K. B. (1976) Acta Crystallographica A32, 778-780.

Jones, T. A., Zou, J.-Y., Cowan, S. W. and Kjeldgaard, M. (1991) Acta Cystallographica A47, 110-119.

Katchalski-Katzir, E., Shariv, I., Eisenstein, M., Friesem, A. A., Aflalo, C. and Vakser, I. A. (1992) Proceedings of the National Academy of Sciences of the United States of America, 89, 2195-2199.

Kuntz, I. D., Meng, E. C. and Shoichet, B. K. (1994) Accounts of Chemical Research, 27, 117-123.

Lattman, E. E. (1972) Acta Crystallographica, B28, 1065-1068.

Morse, P. M. and Feshbach, H. (1953) Methods of Theoretical Physics, p. 1467, McGraw-Hill, New York.

Navaza, J. (1987) Acta Crystallographica, A43, 645-653.

Navaza, J. (1990) Acta Crystallographica, A46, 619-620.

Nissink, J. W. M., Verdonk, M. L., Kroon, J., Mietzner, T., and Klebe, G. (1997) Journal of Computational Chemistry, A32, 638-645.

Podjarny, A. D. and Urzhumtsev, A. (1996) Transactions of the American Crystallographic Association 30, 109-120.

Rossmann, M. G. ed. (1972) The Molecular Replacement Method, Gordon & Breach, New York.

Rossmann, M. G. (1990) Acta Crystallographica, A46, 73-82.

Ten Eyck, L. F. (1973) Acta Crystallographica, A29, 183-191.

Ten Eyck, L. F. (1977) Acta Crystallographica, A33, 486-492.

Tsao, J., Chapman, M. S., and Rossmann, M. G. (1992) Acta Crystallographica, A48, 293-301.

Thus, it can be appreciated that a computational method and an apparatus therefore have been presented which will facilitate the discovery of novel bio-active and/or therapeutic molecules, these methods rely on the use of a computational methods employing a general recursive method for determining the macromolecular crystallographic phases of molecules so as to recognize and predict ligand binding affinity.

Accordingly, it is to be understood that the embodiments of the invention herein providing for a more efficient mode of drug discovery and modification are merely illustrative of the application of the principles of the invention. It will be evident from the foregoing description that changes in the form, methods of use, and applications of the elements of the computational method and associated algorithms disclosed may be resorted to without departing from the spirit of the invention, or the scope of the appended claims.

What is claimed is:

1. A method for determining the three-dimensional structure of a molecule of interest, which comprises
(a) obtaining x-ray diffraction data for crystals of said molecule of interest;
(b) selecting as a basis set an orthogonal set of at least one spherical harmonic spherical Bessel functions to represent the three dimensional electron density in the crystal, such that the number of degrees of freedom in the modeled electron density is reduced relative to the number of measured data;
(c) determining the maximum minimal resolution of said spherical harmonic spherical Bessel model to be used to determine the three-dimensional structure of said molecule of interest;
(d) determining a radius and position for a spherical asymmetric unit in a model crystal lattice as derived from said diffraction data for crystals;
(e) determining a computationally efficient grouping of x-ray diffraction intensities;
(f) modifying, each said at least one spherical harmonic spherical Bessel basis function within the selected basis set such that it represents an individual basis function centered at a specific position and becomes a Fourier representation of a positionally translated basis function;
(g) calculating said at least one Fourier representation of the full-unit cell, symmetry-expanded spherical harmonic spherical Bessel basis function for each basis function in the basis set chosen in (b);
(h) determining at least one complex-valued coefficient of said spherical harmonic spherical Bessel series by comparing said full-unit cell, symmetry-expanded spherical harmonic spherical Bessel basis function determined in (g) with said experimental x-ray diffraction data;
(i) using said at least one complex-valued coefficient of each spherical harmonic spherical Bessel function in the basis set for said spherical harmonic spherical Bessel series to iteratively update a phased Fourier representation of the 3-dimensional electron density of the crystal; and
(j) calculating Fourier summations based on a combination of said phased Fourier representation and the experimental diffraction intensities to obtain an interpretable 3-dimensional representation of the contents of the unit cell.

2. The method of claim 1 further comprising
(k) determining a modeled structure of a diffracting molecule, wherein a three-dimensional model structure of said molecule of interest by using computational graphical model fitting; and
(l) subjecting said three dimensional model structure to improvements by simulated annealing, least squares, maximum entropy, and/or Bayesian data analysis and/or molecular mechanics energy minimizations.

3. The method of claim 1 wherein said radius and position for a spherical asymmetric unit is known.

4. The method of claim 1 wherein said radius and position for a spherical asymmetric unit is not known.

5. The method of claim 4 further comprising calculation of said radius and position of said largest spherical asymmetric unit that can fit into a predetermined crystal lattice with-out overlap.

6. The method of claim 5 further comprising determining the numerical value of the angular increment between each trial value estimated for the phase angle of coefficient of a spherical harmonic spherical Bessel component basis function of said model of said largest spherical asymmetric unit.

7. The method of claim 5 further comprising determining the value of the spherical harmonic spherical Bessel coefficient.

8. The method of claim 1 further comprising determining the total number of m-indices to be provided in a recursive calculation.

9. The method of claim 1 further comprising determining a starting and a final value of an arbitrary exponent by which power to raise the values of calculated correlation coefficients to allow iterative improvement of the modeled electron density.

10. The method of claim 1 further comprising determining said at least one spherical Bessel function of together with ordinate values of a Bessel function argument such that the zeroes of these Bessel functions are calculated.

11. The method of claim 8 further comprising converting said diffraction m-indices to spherical coordinates and initialing said numerical values associated with said diffraction index to allow later recursive calculation of a value of each spherical harmonic Bessel basis function at said diffraction indices.

12. The method of claim 11 further comprising executing a recursive program cycle wherein unphased diffraction amplitudes are converted to a Fourier transform of a calculated model of a portion of a crystal unit cell.

13. The method of claim 1, wherein the results of said method can be further used to accurately predict the identity of ligands or to assess the relative binding affinity of said ligands to said molecule of interest.

14. The method of claim 1, wherein the process for carrying out the elements of said method for determining the three-dimensional structure of a molecule of interest, is contained in a computer, said computer being capable of receiving data and performing said method.

15. The method of claim 15, wherein said computer is coupled to a display device and there exists a means for presenting the chemical or molecular structural characteristics of said at least one molecule of interest on said display device.

16. The method of claim 1, wherein said at least one molecule of interest is selected from the group consisting of:
a) a pharmaceutical;
b) an enzyme;
c) a catalyst;
d) a polypeptide;
e) an oligopeptide;
f) a carbohydrate;
g) a nucleotide;
h) a macromolecular compound;
i) an organic moiety of an alkyl, cycloalkyl, aryl, aralkyl or alkaryl group or a substituted or heterocyclic derivative thereof;
j) an industrial compound;
k) a polymer;
l) a monomer;
m) an oligomer;
n) a polynucleotide;
o) a multimolecular aggregate; and
p) an oligopeptide.

17. The method of claim 1, wherein the chemical characteristics of said molecule of interest are in the form of a three dimensional representation, said three dimensional representation allowing the identification of the molecular features of said molecular object such that said representation could be used to determine desirable chemical characteristics of said at least one molecule of interest.

18. The method of claim 1, wherein the structural characteristics of said molecule of interest are in the form of a three dimensional representation, said three dimensional representation allowing the identification of the molecular features of said molecular object such that said representation could be used to determine structural characteristics of said at least one molecule of interest that could be modified.

19. The method of claim 1, wherein said method is further utilized to predict the chemical activity of at least one molecule of interest.

20. The method of claim 1, wherein said method is further utilized to predict the biochemical activity of at least one molecule of interest.

21. The method of claim 1, wherein said method is further utilized to predict the physiological activity of at least one molecule of interest.

22. The method of claim 1 further comprising depicting a three-dimensional structure of said molecule of interest from the summation of said at least one Fourier representation.

23. The method of claim 22 further comprising generating a three-dimensional model structure of said molecule of interest from said three-dimensional structure of said molecule of interest from the summation of said at least one Fourier representation.

24. A molecule of interest as identified through the method of claim 1.

25. The molecule of interest of claim 24 wherein said molecule of interest is determined to have some chemotherapeutic activity.

26. The molecule of interest of claim 24 wherein said molecule of interest is determined to have some pharmacotherapeutic activity.

27. The molecule of interest of claim 24 wherein said molecule of interest is modified as determined by the method of claim 1 to optimize the chemotherapeutic characteristics of said molecule of interest.

28. The molecule of interest of claim 24 wherein said molecule of interest is determined to have some pharmacotherapeutic activity.

29. A molecule of interest as identified through the method of claim 1 that is determined to be effective as a therapeutic agent.

30. The molecule of interest of claim 29 wherein said molecule of interest is modified as to optimize the chemotherapeutic characteristics of said molecule of interest.

31. The molecule of interest of claim 29 wherein said molecule of interest is modified as to optimize the pharmacotherapeutic characteristics of said molecule of interest.

32. The molecule of interest of claim 30 wherein said molecule of interest is chemically modified as to optimize the chemotherapeutic characteristics of said molecule of interest.

33. The molecule of interest of claim 31 wherein said molecule of interest is chemically modified as to optimize the pharmacotherapeutic characteristics of said molecule of interest.

34. The molecule of interest of claim 30 wherein said molecule of interest is structurally modified as to optimize the chemotherapeutic characteristics of said molecule of interest.

35. The molecule of interest of claim 31 wherein said molecule of interest is structurally modified as to optimize the pharmacotherapeutic characteristics of said molecule of interest.

36. The molecule of interest of claim 29, wherein said at least one molecule of interest is selected from the group consisting of:
a) a pharmaceutical;
b) an enzyme;
c) a catalyst;
d) a polypeptide;
e) an oligopeptide;
f) a carbohydrate;
g) a nucleotide;
h) a macromolecular compound;
i) an organic moiety of an alkyl, cycloalkyl, aryl, aralkyl or alkaryl group or a substituted or heterocyclic derivative thereof;
j) an industrial compound;
k) a polymer;
l) a monomer;
m) an oligomer;
n) a polynucleotide;
o) a multimolecular aggregate; and
p) an oligopeptide.

37. The method of claim 1, wherein said x-ray diffraction data for crystals further comprises data representing the crystal space group, the crystal symmetry operators, the crystal lattice dimensions and angles, the maximum resolution of the experimental diffraction data, the experimentally measured values of the x-ray diffraction intensities, the derived values of the x-ray structure factor amplitudes, and an input value chosen for the maximum minimal resolution of the spherical harmonic, spherical Bessel (SHSB) model of said molecule of interest.

38. The molecule of interest of claim 1, wherein said molecule is Staphyloccocal nuclease.

39. The method of claim 1 further comprising inputting a numerical value for the angular increment between each trial value presumed for the phase angle of coefficient of the complex-valued individual origin-centered spherical harmonic spherical Bessel (SHSB) coefficient

40. The method of claim 1 further comprising determining an appropriate value of said angular increment automatically for each phase angle of coefficient of the complex-valued individual origin-centered spherical harmonic spherical Bessel (SHSB) coefficient.

41. The method of claim 1 further comprising:
(k) determining, from the input limiting resolution for the origin-centered spherical harmonic spherical Bessel model, the extent of the indices in, of the component SHSB basis functions that are required for said molecule of interest.
(l) converting diffraction indices (hkl) to spherical coordinates,
(m) initializing some numerical values associated with each diffraction index to allow later recursive calculation of the value of each spherical harmonic spherical Bessel basis function at each hkl index; and
(n) executing a recursive program cycle.

42. The method of claim 41 further comprising:
(o) inputting the observed experimental diffraction amplitudes for each hkl index in the Fourier representation;
(p) converting a set of SHSB coefficients to at least one Fourier representation; and
(q) combining the contributions from the l, m, and n components of said at least one Fourier representation of the origin-centered, individual SHSB basis function to provide a full 3-dimensional Fourier representation of the origin-centered individual SHSB basis function of said molecule of interest.

43. The method of claim 1 further comprising writing information concerning the three dimensional Fourier representation of the model of said crystal of said molecule of interest to an electronic record keeper, the Fourier representation of each stored SHSB model such that it may be read at the beginning of the calculation for the next packet of m-values for the SHSB indices.

44. The method of claim 1, wherein the steps and calculations necessary for the determination of the depiction of said molecule of interests is capable of being recorded in an electronic medium.

45. The method of claim 1, wherein the steps and calculations necessary for the determination of the depiction of said molecule of interests is recorded in an electronic medium are stored in a secondary storage device.

46. The method of claim 1, wherein said method includes a display device such as a monitor.

47. The method of claim 43 wherein said method further provides a backup memory means to record the steps and calculations is selected from the group consisting of:
a) a floppy disk;
b) a second hard disk drive;
c) a read/write compact disc;
d) magnetic tape;
e) a Bernoulli Box;
f) a Zip disk; and
g) other means for storing electronic data

48. A method for determining the three-dimensional structure of a molecule of interest, which comprises
(a) obtaining x-ray diffraction data for crystals of said molecule of interest;
(b) choosing, as the basis set, an orthogonal set of at least one, but more often several spherical harmonic spherical Bessel functions to represent the 3-dimensional electron density in the crystal, such that the number of degrees of freedom in the modeled electron density is reduced relative to the number of measured data;
(c) determining the maximum minimal resolution of said spherical harmonic spherical Bessel model to be used to determine the three-dimensional structure of said molecule of interest;
(d) determining a radius and position for a spherical asymmetric unit in a model crystal lattice as derived from said diffraction data for crystals;
(e) determining a computationally efficient grouping of x-ray diffraction intensities;
(f) modifying, in turn, each said spherical harmonic spherical Bessel basis function within the selected basis set such that it represents an individual basis function centered at a specific position and becomes a Fourier representation of a positionally translated basis function;
(g) calculating said at least one Fourier representation of the full-unit cell, symmetry-expanded spherical harmonic spherical Bessel basis function for each basis function in the basis set chosen in (b);
(h) determining the complex-valued coefficients of said spherical harmonic spherical Bessel series by comparing said full-unit cell, symmetry-expanded spherical harmonic spherical Bessel basis function determined in (g) with said experimental x-ray diffraction data;
(i) using said determined coefficients of each spherical harmonic spherical Bessel function in the basis set for said spherical harmonic spherical Bessel series to update iteratively a phased Fourier representation of the 3-dimensional electron density of the crystal; and
(j) calculating Fourier summations based on a combination of said phased Fourier representation and the experimental diffraction intensities to obtain an interpretable 3-dimensional representation of the contents of the unit cell.
wherein the chemical characteristics of said molecule of interest are in the form of a three dimensional representation, said three dimensional representation allowing the identification of the molecular features of said quantum object such that said representation could be used to alter to the chemical characteristics of said at least one molecule of interest.

49. The method of claim 48 wherein said spherical harmonic model to be used is the spherical Bessel mode.

50. The method of claim 48 wherein said radius and position for a spherical asymmetric unit is known.

51. The method of claim 48 wherein said radius and position for a spherical asymmetric unit is not known.

52. The method of claim 48 further comprising writing information concerning the three dimensional structure of said molecule of interest to an electronic record keeper, the Fourier representation of each stored SHSB model such that it may be read at the beginning of the calculation for the next packet of m-values for the SHSB indices.

53. The method of claim 48, wherein the steps and calculations necessary for the determination of the depiction of said molecule of interests is capable of being recorded in an electronic medium.

54. A molecule of interest as identified through the method of claim 48.

55. The molecule of interest of claim 54 wherein said molecule of interest is determined to have some chemotherapeutic activity.

56. The molecule of interest of claim 54 wherein said molecule of interest is modified as determined by the method of claim 1 to optimize the chemotherapeutic characteristics of said molecule of interest.

57. A molecule of interest as identified through the method of claim 48 that is determined to be effective as a therapeutic agent.

58. The molecule of interest of claim 57 wherein said molecule of interest is modified as to optimize the pharmacotherapeutic characteristics of said molecule of interest.

59. The molecule of interest of claim 57 wherein said molecule of interest is chemically modified as to optimize the chemotherapeutic characteristics of said molecule of interest.

60. The molecule of interest of claim 57, wherein said at least one molecule of interest is selected from the group consisting of:
a) a pharmaceutical;
b) an enzyme;
c) a catalyst;
d) a polypeptide;
e) an oligopeptide;
f) a carbohydrate;
g) a nucleotide;
h) a macromolecular compound;
i) an organic moiety of an alkyl, cycloalkyl, aryl, aralkyl or alkaryl group or a substituted or heterocyclic derivative thereof,
j) an industrial compound;
k) a polymer;
l) a monomer;
m) an oligomer;
n) a polynucleotide;
o) a multimolecular aggregate; and
p) an oligopeptide.

61. The method of claim 48, wherein the chemical characteristics of said molecule of interest are in the form of a three dimensional representation, said three dimensional representation allowing the identification of the molecular features of said quantum object such that said representation could be used to alter to the chemical characteristics of said at least one molecule of interest.

62. The method of claim 48, wherein said method is further utilized to predict the chemical activity of at least one molecule of interest.

63. A method of drug design comprising the step of using the three-dimensional structure of a molecule of interest as determined by the method of claim 1, to computationally evaluate a chemical entity for associating with the active site of a molecule of interest.

64. The method according to claim 63, wherein said chemical entity is a competitive or non-competitive inhibitor of said molecule of interest.

65. The method of drug design according to claim 63 comprising the step of using the structure coordinates of said molecule of interest to identify an intermediate in a chemical reaction between said molecule of interest and a compound which is a substrate or inhibitor of said molecule of interest.

66. The method of drug design according to claim 63, wherein said chemical entity is an inhibitor of said molecule of interest and is selected from a database.

67. The method according to claim 63, wherein said chemical entity is designed de novo.

68. The method according to claim 63, wherein said chemical entity is designed from a known inhibitor of said molecule of interest.

69. The method according to claim 63, wherein said step of employing said three-dimensional structure to design or select said chemical entity comprises the steps of:
(a). identifying molecules or molecular fragments capable of associating with molecule of interest as determined by the method of claim 1; and
(b). assembling the identified molecules or molecular fragments into a single modified molecule to provide the structure of said chemical entity.
